(19) United States
(12) Patent Application Publication
(10) Pub. No.: US 2008/0067008 A1
(43) Pub. Date: Mar. 20, 2008

(54) ELEVATOR INSTALLATION WITH AN ELEVATOR SUPPORT MEANS, ELEVATOR SUPPORT MEANS FOR SUCH AN ELEVATOR INSTALLATION AND PRODUCTION METHOD FOR SUCH ELEVATOR SUPPORT MEANS

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/836,430

(22) Filed: Aug. 9, 2007

Related U.S. Application Data
(60) Provisional application No. 60/822,129, filed on Aug. 11, 2006.

(30) Foreign Application Priority Data
Aug. 11, 2006 (EP) 06118817.3

(51) Int. Cl. B66B 7/00; B29D 29/00

(52) U.S. Cl. 187/250; 474/238

(57) ABSTRACT

A lift installation according to the invention comprises a drive unit (2) which by way of a drive wheel (4.1) drives at least one lift support means (12) supporting a lift cage (3), wherein the lift support means has on a traction side facing the drive wheel (4.1) a rib arrangement with at least two ribs (13) which extend in longitudinal direction of the lift support means and which engage in corresponding grooves on the drive wheel, wherein the rib arrangement comprises a tensile carrier arrangement with at least one tensile carrier (14) arranged in a rib. The lift support means has on a belt back side remote from the traction side a carrier band (15) to which the ribs of the rib arrangement are fastened. A groove (16) reaching substantially as far as the carrier band is formed between two adjacent ribs (13) of the rib arrangement.

The present invention relates to a lift installation with a lift support means, a lift support means for such a lift installation and a production method for such a lift support means.

A lift installation comprises a lift cage and usually a counterweight, which are movable in a lift shaft or along free-standing guide devices. For producing the movement, the lift installation comprises at least one drive unit with at least one drive wheel, which supports the lift cage and the counterweight by way of one or more lift support means in the form of belts and/or transmits the required drive forces to the cage and counterweight.

A lift installation according to category is known from EP 1 555 234 B1, in which the belt has on a traction side facing the drive wheel a rib arrangement with several wedge-shaped ribs, which extend in longitudinal direction of the belt and which engage in corresponding grooves on the drive wheel. Due to the fact that the contact between the belt and the drive wheel takes place by way of the inclined flanks of the wedge-shaped ribs and grooves respectively, the pressing pressure against the drive wheel and thus the traction capability or drive capability increases for the same radial force and therefore the same bearing loading and belt tension. At the same time the wedge ribs advantageously guide the belt in transverse direction on the drive wheel. Since the belts contain tensile carriers with relatively small diameters, it is possible to use drive wheels with smaller diameters. In particular, the drive output shaft of the drive unit can itself also be constructed as drive wheel.

A single, freely movable wedge rib advantageously centres itself in a corresponding groove of a drive wheel or a deflecting wheel by way of the inclined flanks, wherein compensation for production tolerances and wear of the belt, which has the wedge rib, and/or of the drive wheel itself is provided by radial engagement of the wedge rib in the groove to different depths. Thus, for example, a wedge belt, which due to wear of its wedge flanks has a width smaller relative to the nominal dimension, rests deeper in radial direction in a complementary groove which, due to production tolerances, has a width greater relative to its nominal dimension. Nevertheless, by virtue of the wedge flanks the belt lies centred in the groove of the drive wheel under friction couple. Overall, a freely movable wedge rib can provide compensation for deviations in shape resulting from production tolerances of the rib and/or the associated groove in the drive wheel and also from wear of rib and/or groove. At the same time, several relatively movable wedge ribs can provide compensation for positional deviations, particularly different spacings of the ribs and grooves from one another, in belt transverse direction and also in radial direction of the drive wheel.

If the rib arrangement comprises, as in EP 1 555 234 B1, several wedge ribs formed on the same belt body, this self-centring and compensation for deviations in shape and/or position of the individual ribs and associated grooves are no longer possible. In addition, deviations in the spacings of the individual ribs and/or grooves relative to one another disadvantageously have the consequence that not all wedge ribs are disposed in homogeneous engagement with the associated grooves.

The belt body is usually made of an elastomer which, due to its elasticity does indeed allow a certain relative movement of the individual ribs and thus enables the above-described self-centring and compensation for positional and shape deviations of the ribs and grooves to a limited extent. It is disadvantageous that this compensation is possible only within close limits and under significant elastic deformation of the belt body, wherein this deformation leads to premature ageing of the belt due to the alternating tensile, compressive and shear stresses connected therewith. This obliges a higher level of maintenance effort for the lift installation, since the belt has to be more frequently checked and exchanged. In addition, the elastic deformation of the belt body increases the risk that individual ribs do not completely bear in the grooves, but in part work out of this, whereby the guidance of the belt on the . . .

A belt for a belt drive is known from U.S. Pat. No. 3,996,813, which comprises individual wedge ribs, which are connected only by a carrier band of an elastomer, with tensile carriers arranged therein. By contrast to a lift installation in which the relative position between drive and deflecting wheels, around which the belt runs, constantly changes, in the belt drive of U.S. Pat. No. 3,996,813 the driving and driven drive pulleys are inertially fixed so that a high level of stiffness in belt transverse direction is not necessary here. In addition, variable run lengths, such as occur in a lift installation and hamper the use of belts which are soft in transverse direction, do not occur in such a belt drive, because with large free run lengths and drive or deflecting wheels moving relative to one another soft belts have a tendency to twist about the longitudinal axis thereof and to bend in transverse direction. Moreover, in the belt drive discussed in U.S. Pat. No. 3,996,813 the belt is deflected only over its traction side so that its belt rear side remote therefrom is free of contact, whereas in lift installations with fixed and free deflecting wheels the lift support means frequently also loops around deflecting wheels by its belt rear side.

Accordingly, the specification also proposes an elastomer carrier band, which is reinforced with tire cord threads and which does indeed satisfactorily connect with the elastomer wedge ribs, but has only a low transverse stability and wear resistance on the belt rear side. The belt known from U.S. Pat. No. 3,996,813 is therefore unsuitable for use in a lift installation in which the run regions, which in part are long, between drive and deflecting wheels, the variable run lengths and the deflection also over the belt rear side impose higher demands on the transverse stability and wear resistance of the belt.

The object of the present invention is to construct a lift installation, which is known from EP 1 555 234 B1, to be lower in maintenance.

For this purpose a lift installation according to the introductory part of claim 1 is developed by the characterising features thereof. In claim 9 a lift support means for such a lift installation is made available and in claim 9 a method for production thereof is indicated.

A lift installation according to the invention comprises a drive unit which by way of a drive wheel drives at least one lift support means supporting a lift cage, wherein the lift support means has on a traction side facing the drive wheel a rib arrangement with at least two ribs, which extend in longitudinal direction of the lift support means and which engage in corresponding grooves on the drive wheel. For transmission of the tensile force in the lift support means the belt arrangement comprises a tensile carrier arrangement with at least one tensile carrier arranged in a rib.

In a preferred embodiment at least one tensile carrier, with particular preference more than one tensile carrier, is or are arranged in each rib. In an alternative embodiment a tensile carrier is not associated with each of the ribs. The ribs which do not have tensile carriers can transmit only a small part of the tension force of the lift support means, but serve for guidance and centring of the belt in transverse direction.

According to the invention it is now proposed that a groove is formed between two adjacent ribs of the rib arrangement and reaches substantially up to a carrier band which is arranged on the belt rear side of the lift support means remote from the traction side and to which the ribs of the rib arrangement are fastened.

The two ribs separated by the groove can thereby move relative to one another in transverse and/or height direction of the lift support means. This makes it possible for the at least two adjacent ribs to provide compensation for deviations in shape, particularly the width of the respective rib relative to the associated groove of the drive wheel and/or deviations in position of the ribs and/or grooves relative to one another, through this relative movement and to centre in the grooves without deforming the rib bodies. This reduces the stresses arising in the ribs and thereby increases the service life thereof. As a consequence, the maintenance outlay in the lift installation reduces due to the longer inspection intervals and the less frequent exchange of the belt.

In a preferred embodiment all ribs of the rib arrangement are separated from one another by respective grooves. This enables the above-explained compensation for position and shape tolerances between all ribs.

In an alternative embodiment of the present invention not all ribs of the rib arrangement are separated by a respective groove. Even in this form of embodiment a compensation for positional deviations of the rib blocks separated by the groove or grooves is still possible, whereby there is avoidance, in particular, of formation of high material stresses over the entire width of the belt due to the deviations in position and/or shape. Instead thereof, due to the smaller positional deviations in each instance only smaller deformations arise within a rib block. On the other hand, less grooves reduce the transverse stiffness of the belt correspondingly less. For example, a groove is formed only between the two middle ribs of the lift support means.

Preferably the grooves reach up to the said carrier band, so that the adjacent ribs separated from one another by a groove are completely separated from one another. This allows a maximum movability of the ribs relative to one another, wherein elastic deformations of the rib body are reduced. For increase in transverse stiffness, but also for improved fastening of the ribs to the carrier band, the grooves can, however, also end shortly in front of the carrier band so that a thin web of rib material connecting the ribs remains on the carrier band. A greater connecting area between ribs and carrier band is thereby available. Advantageously such a web has approximately the thickness of the carrier band.

The ribs of the rib arrangement preferably have a contact section with a substantially trapezium-shaped or wedge-shaped cross-section for engagement in the corresponding grooves of the drive wheel. With such wedge ribs the pressing force of the belt against the drive wheel increases, and thus the drive or traction capability, for the same radial force, i.e. for the same bearing loading and belt tension. In that case cross-sections with a flank angle between 60° and 120°, preferably 75° and 105° and particularly preferably 90°, have proved particularly advantageous.

The wedge flanks of these wedge ribs can reach almost up to the carrier band, which maximises the contact area with the flanks of the drive wheel grooves. This on the one hand reduces, due to the greater contact area, the wear of the ribs and grooves co-operating by friction couple. On the other hand, for the same rib spacing and the same wedge angle the height of the ribs reduces and thus their capability of being able to compensate for deviations in position and shape.

In an alternative embodiment the ribs of the rib arrangement have a base section, which lies between the contact section and the carrier band and the flanks of which have an angle relative to the carrier band different from that of the wedge flanks of the contact section. In particular, the base section can have a substantially rectangular cross-section or a trapezium-shaped cross-section with a smaller flank angle, i.e. with steeper flanks. This enables formation of higher ribs with less stiffness in bending, the ribs being particularly suitable for providing compensation for positional and shape deviations, which may be present, between the ribs of the belt and the grooves of the drive or deflecting wheels. Closely adjacent side surfaces of relatively high base sections also increase the transverse stiffness of the belt, since the opposite flanks of narrow grooves already make contact in the case of relatively small tipping of adjacent ribs. Excessive twisting of the belt about the longitudinal axis thereof is thus avoided particularly in the long, free run sections resulting in the case of a lift installation with a cage in the uppermost or lowermost storey. Advantageously the groove width, i.e. the narrowest spacing between opposite flanks of adjacent ribs, is approximately 10%, preferably 5% and particularly preferably 2.5%, of the (maximum) rib width. Particularly polyamide (PA), polypropylene (PP), polyethylene (PE), polycarbonate (PC) or polyvinylchloride (PVC) or polyblend and/or of a fabric of such a thermoplastic plastics material.

The tensile carriers are arranged in the ribs and contact the carrier band. In this manner the tensile carriers support the carrier band, which can be constructed to be corresponding thin and flexible. At the same time, the tensile carriers arranged at the carrier band and thus at the base of the individual ribs connected therewith increase the stiffness of the base region of the ribs. The deformations, particularly archings of the contact surface of the ribs relative to the carrier band, thereby reduce, which reduces the loading of the connection and thus counteracts detaching of the ribs from the carrier band. By contrast thereto, the upper region of the ribs free of tensile carriers is correspondingly more resilient and can absorb the compression or tension deformations resulting from the belt bending as well as better provide compensation for the afore-mentioned deviations in shape and position. The tensile carriers are preferably arranged in the neutral axis of the belt or in the vicinity thereof.

In production of the belt the tensile carriers can be advantageously pressed under bias onto the carrier band before the ribs are mounted on the carrier band in such a manner that they completely enclose the tensile carriers. By virtue of the bias the tensile carriers are fixed in correct position on the carrier band during production process. The biasing of the tensile carriers makes it possible to, for example, impose on the belt a concave intrinsic curvature towards the traction side, which can be useful in lift installations in which the drive and deflecting wheels are so arranged that the belt is always bent in the same sense of bending.

The tensile carriers of the tensile carrier arrangement can be constructed as a single wire or consist of singly or multiply stranded strands or cables, wherein the strands or cables can be made of steel wires or synthetic material fibres. It is also possible to construct different tensile carriers in different manner. By virtue of this and/or due to the arrangement of different tensile carrier numbers in the individual ribs it is possible to predetermine a distribution of stiffness for the belt. Thus, for example one rib can have two or more doubly or multiply stranded individual wires, whilst in another rib several tensile carriers are arranged which in turn have less individual wires. It is thus possible to achieve, for example, a decrease in the longitudinal stiffness of the belt from the belt centre towards the belt edge, whereby in the case of a slight skewed setting of the axes of the drive and deflecting wheels or even in the case of slight axial offset the outwardly disposed ribs of the belt can, by virtue of their lesser stiffness, provide compensation for these deviations.

In a preferred embodiment the ribs are made of a first material which comprises an elastomer, particularly polyurethane, polychloroprene and/or ethylene-propylene-diene rubber. Ribs of elastomeric material can, by virtue of their elasticity, provide compensation to a certain extent for deviations in shape and position and thus reduce the relative movement of the ribs necessary for this purpose. At the same time they are particularly suitable for the friction-coupling contact with a drive wheel and for the transmission of the tensile forces from this to the tensile carriers. In addition, they advantageously damp vibrations and shocks and thus increase the comfort of the lift installation. In that case ribs with a hardness of 70 to 100 Shore (A), preferably 75 to 95 Shore (A) and particularly preferably a hardness of 80 to 85 Shore (A), have proved particularly favourable. Due to the separation in accordance with the invention of the ribs by grooves the ribs do not have to deform or have to deform only slightly when there are shape and/or positional deviations of ribs and grooves, so that the aforesaid relatively stiff or hard elastomers can be used.

Advantageously the carrier band is made of a second material comprising a thermoplastic plastics material, particularly polyamide (PA), polypropylene (PP), polyethylene (PE), polycarbonate (PC) or polyvinylchloride (PVC) or polyblend and/or of a fabric of such a thermoplastic plastics material. Equally, use can also be made of a mixture of different thermoplastic plastics materials, i.e. a so-termed polyblend. The second material can preferably also comprise a fabric of such a thermoplastic plastics material.

The mentioned thermoplastic plastics material have, by contrast to elastomers, a sufficient strength in order to withstand the stresses, which occur between the individual ribs, in belt transverse direction (due to shape and/or positional deviations), but also shear stresses due to different groove diameters or rib heights or a transverse running of the belt. Insofar as, for example, a groove diameter and/or a rib height is smaller than the diameter or height of an adjacent groove or rib then the circulation speed of this rib correspondingly reduces relative to the adjacent rib, which leads to a shear stress in the carrier band connecting these.

By contrast to an elastomeric carrier band as is known from U.S. Pat. No. 3,996,813, a thermoplastic carrier band according to the present invention does not necessarily have to be reinforced with cords in belt transverse direction. Such a reinforcement is obviously possible and allows a corresponding thinner carrier band.

A further advantage of a thermoplastic carrier band resides in its good sliding properties, particularly its wear resistance and/or its low coefficient of friction. If, for example, as is frequently the case in lift installations the lift support means is deflected singly or multiply over fixed or floating deflecting wheels for reduction in tension forces in block-and-tackle-like manner, wherein it partly loops around the deflecting wheels by its belt rear side remote from the traction side, a thermoplastic carrier band advantageously reduces the friction occurring between the deflecting wheels and the belt. Advantageously there are thereby reduced, in particular, the friction force which has to be overcome for lateral guidance of the belt on a deflecting wheel, thus the lateral loading of the belt, for example by guide flanges of deflecting wheels, and as a consequence also the required drive power of the lift installation. At the same time the service life of the belt as also that of the deflecting wheels are extended. The wear resistance of the belt rear side is improved at the same time so that in turn the service life of the lift support means increases. Advantageously, the belt rear side of the thermoplastic carrier band can for this purpose have a coefficient of friction of at most 0.4, preferably at most 0.3 and particularly preferably at most 0.25.

In order to keep the loading of the carrier band as small as possible, the ribs can be arranged thereon at a spacing from one another which advantageously is slightly greater than the spacing of the associated ribs of the friction wheel. Insofar as no positional or shape deviations are present, the carrier band relieved of stress between the ribs and can correspondingly fold or arch due to its elasticity. In this state the tensile force is appropriately uniformly distributed to the individual belts which transmit this by means of their tensile carriers. Insofar as ribs move towards one another due to a positional and/or shape deviation of ribs and/or grooves, the carrier band arches or folds correspondingly more strongly without impairing operation of the lift installation. For this purpose the carrier band can advantageously have a bias in belt transverse direction, which leads to a concave arching of the carrier band away from the drive wheel. To the extent that the ribs move away from one another due to a positional and/or shape deviation of ribs and/or grooves initially the loose carrier band is drawn taut between the ribs so that the carrier band itself is still not elastically deformed. This advantageously reduces the elastic deformation of the carrier band and thus increases the service life thereof. At the same time, the carrier band allows, by virtue of its elasticity in transverse direction, also movement apart of the ribs beyond the setting in which the carrier band is completely taut and thus creates, with simultaneous minimisation of the deformation of the carrier band occurring in operation, a further area of compensation.

In order to guarantee the afore-described effects of the carrier band, this has a thickness of at most 0.5 millimetres or at most a tenth of the entire belt thickness.

A lift support means according to the invention is preferably produced in that initially the tensile carriers are arranged on the carrier band and subsequently the ribs are mounted on the carrier band, for example by means of an extrusion process, wherein a groove reaching substantially as far as the carrier band is formed between at least two adjacent ribs. In that case the tensile carriers are simultaneously incorporated in the ribs. In an advantageous embodiment the tensile carriers are for this purpose pressed under bias onto the carrier band so as to fix them correct in position during the production process of the belt.

Preferably the first material in that case contains an adhesive which thermally glues the ribs to the carrier band when being extruded on. In an alternative embodiment initially the individual ribs are extruded, wherein the tensile carriers are fed to them. The ribs are subsequently connected with the carrier band by thermal adhesion.

Further objects, features and advantages are evident from the subclaims and the examples of embodiment described in the following. With respect thereto:

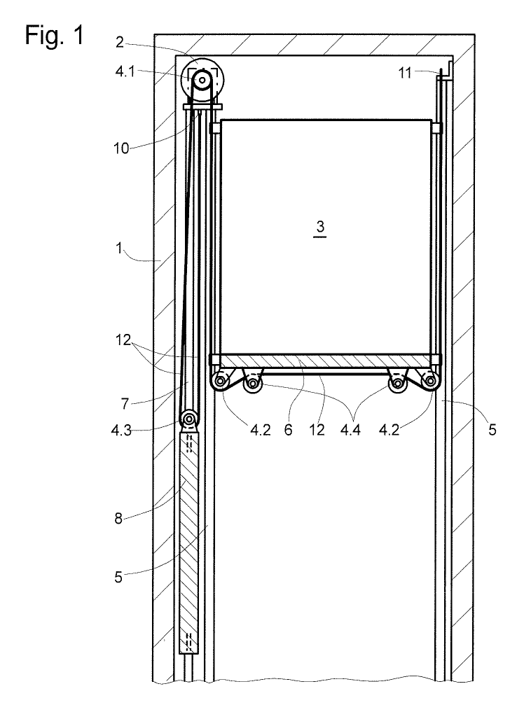

FIG. 1 shows a section, which is parallel to a lift cage front, through a lift installation according to an embodiment of the present invention; and

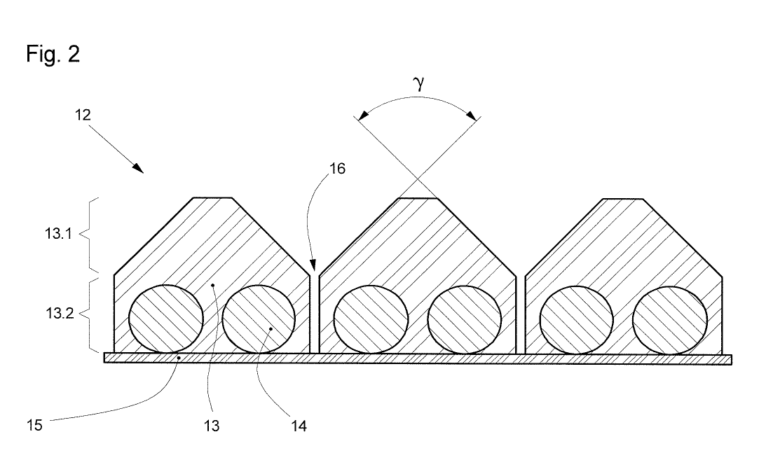

FIG. 2 shows a cross-section through a belt according to an embodiment of the present invention.

FIG. 1 schematically shows a section through a lift installation, which is installed in a lift shaft 1, with the belt 12. The lift system comprises a drive unit 2, which is fixed in a lift shaft 1, with a drive wheel 4.1, a lift cage 3, which is guided at cage guide rails 5, with deflecting wheels, which are mounted below the cage floor 6, in the form of cage support rollers 4.2, a counterweight 8, which is guided at counterweight guide rails 7, with a further deflecting wheel in the form of a counterweight support roller 4.3, and a lift support means in the form of a belt 12 for the cage 3 and the counterweight 8, which transmits the drive force from the drive wheel 4.1 of the drive unit 2 to the lift cage and the counterweight.

The belt 12 is fastened at one of its ends below the drive wheel 4.1 at a first belt fixing point 10. From this it extends downwardly as far as the counterweight support roller 4.3, loops around this and extends from this to the drive wheel 4.1, loops around this and runs downwardly along the cage wall at the counterweight side, loops around in each instance by 90° respective cage support rollers 4.2 mounted on both sides of the lift cage below the lift cage 3 and runs upwardly along the cage wall, which is remote from the counterweight 8, to a second belt fixing point 11.

The plane of the drive wheels 4.1 can be arranged at right angles to the cage wall and the counterweight side and its vertical projection can lie outside the vertical projection of the lift cage 3. It is therefore to be preferred that the drive wheel 4.1 has a small diameter, so that the spacing between the cage wall at the lefthand side and the wall of the lift shaft 1 opposite thereto can be as small as possible. Moreover, the small drive wheel diameter enables use of a gearless drive motor with relatively low drive torque as drive unit 2.

FIG. 2 shows a cross-section through the belt 12. This comprises a carrier band 15 of polyamide, which is produced, for example, in an extrusion method. Tensile carriers 14 of multiply stranded steel wires are subsequently pressed under bias onto this carrier band 15 and thus fixed in their positional arrangement relative to one another. Individual ribs 13 of polyurethane are subsequently extruded onto the carrier band and in that case connected therewith, wherein the rib material extruded on partly encloses the tensile carriers 14 fully bearing against the carrier band 15.

Each rib 13 is separated from its adjacent ribs by a groove 16, which in the example of embodiment reaches up to the carrier band 15 so that each rib 13 is separately fastened to the carrier band 15. Two respective tensile carriers 14 are symmetrically received in each rib.

In the example of embodiment a rib 13 comprises a base section 13.2, which is connected with the carrier band 15 by being extruded on, with a substantially rectangular cross-section, the side flanks of which define the grooves 16. A contact section 13.1 with trapezium-shaped cross-section is formed continuously with this base section 13.2 and is provided for friction-locking engagement in a correspondingly shaped groove of the drive wheel 4.1.

The individual wedge ribs 13 are movable relative to one another under deformation of the carrier band 15 and can thus provide compensation for deviations of the ribs and grooves in position and shape. In particular, two adjacent wedge ribs can change their spacing from one another in both transverse direction and height direction of the belt 12 and thus engage in grooves, which are formed with different spacings apart, different depth and/or different shape, in the drive wheel 4.1.

The drive wheel 4.1 and the counterweight support roller 4.3 are provided at the periphery thereof with grooves which are formed to be substantially complementary to the contact sections 13.1 of the belt 12. Where the belt 12 loops around one of the belt wheels 4.1 and 4.3 the contact sections lie in corresponding grooves of the belt wheel, whereby excellent of guidance of the belt on these belt wheels is ensured. Moreover, the traction capability is improved by the wedge action arising between the grooves of the drive wheel 4.1 and the ribs of the belt 12.

The cage support rollers 4.2 are so looped around by the belt 12 that the unprofiled belt backs, which are formed by the support band 15, are in contact with the cage support rollers. In order to ensure lateral guidance of the belt 12 on the cage support rollers 4.2, two guide rollers 4.4 provided with grooves are mounted at the cage base 6, the grooves of the rollers co-operating with the ribs of the belt 12.

1. Lift installation with a drive unit (2) which by way of a drive wheel (4.1) drives at least one lift support means (12) supporting a lift cage (3), wherein the lift support means has on a traction side facing the drive wheel (4.1) a rib arrangement with at least two ribs (13) which extend in longitudinal direction of the lift support means and which engage in corresponding grooves on the drive wheel, wherein the rib arrangement comprises a tensile carrier arrangement with at least one tensile carrier (14) arranged in a rib, characterised in that
the lift support means has on a belt back side remote from the traction side a carrier band (15) to which the ribs of the rib arrangement are fastened and that
a groove (16) reaching substantially as far as the carrier band is formed between two adjacent ribs (13) of the rib arrangement.

2. Lift installation according to claim 1, wherein the ribs (13) of the rib arrangement have a contact section (13.1) with a substantially trapezium-shaped cross-section for engagement in corresponding grooves of the drive wheel (4.1).

3. Lift installation according to claim 2, wherein the ribs (13) of the rib arrangement have a base section (13.2) with a substantially rectangular cross-section between the contact section and the carrier band.

4. Lift installation according to any one of the preceding claims, wherein the tensile carriers are arranged in the ribs and contact the carrier band.

5. Lift installation according to any one of the preceding claims, wherein the tensile carriers of the tensile carrier arrangement are constructed as a single wire and/or built up from one or more stranded wires, wherein the individual wires are made of steel and/or synthetic material.

6. Lift installation according to any one of the preceding claims, wherein the ribs are made of a first material comprising an elastomer, particularly polyurethane (PU), polychloroprene (CR) and/or ethylene-propylene-diene rubber (EPDM).

7. Lift installation according to any one of the preceding claims, wherein ribs have a hardness of 70 to 100 Shore (A), preferably 75 to 95 Shore (A) and particularly preferably a hardness of 80 to 85 Shore (A).

8. Lift installation according to any one of the preceding claims, wherein the ribs have a wedge-shaped or trapezium-shaped cross-section with a flank angle γ of 60° to 120°, preferably 80° to 100°.

9. Lift installation according to any one of the preceding claims, wherein the carrier band is made of a second material comprising a thermoplastic plastics material, particularly polyamide (PA), polypropylene (PP), polyethylene (PE), polycarbonate (PC) or polyvinylchloride (PVC) or polyblend and/or a fabric of such a thermoplastic plastics material.

10. Lift support means (12) for a lift installation according to any one of the preceding claims, which comprises the following components:
a rib arrangement with at least two ribs (13) extending in longitudinal direction of the lift support means;
a tensile carrier arrangement with at least one tensile carrier (14), which is incorporated in a rib of the rib arrangement; and
a carrier band (15) to which the ribs of the rib arrangement are fastened, wherein a groove (16) reaching substantially as far as the carrier band is formed between two adjacent ribs (13) of the rib arrangement.

11. Production method for a lift support means according to claim 10, comprising the steps:
arranging the tensile carrier arrangement in the rib arrangement in such a manner that at least one tensile carrier is incorporated in a rib; and
fastening the rib arrangement to the carrier band in such a manner that a groove (16) reaching substantially as far as the carrier band is formed between two adjacent ribs (13) of the rib arrangement.
